(19) United States
(12) Patent Application Publication
(10) Pub. No.: US 2006/0242012 A1
(43) Pub. Date: Oct. 26, 2006

(54) Determining or scoring properties to solicit to join ad network using advertiser or aggregated advertiser interest

(76) Inventors: Sumit Agarwal, San Carlos, CA (US); Brian Axe, San Francisco, CA (US); Gregory Joseph Badros, Mountain View, CA (US); Gokul Rajaram, Mountain View, CA (US); Hunter Walk, San Francisco, CA (US); Leora Wiseman, Sunnyvale, CA (US)

Correspondence Address: STRAUB & POKOTYLO, 620 TINTON AVENUE, BLDG. B, 2ND FLOOR, TINTON FALLS, NJ, 07724, US

(21) Appl. No.: 11/112,715

(22) Filed: Apr. 22, 2005

(51) Int. Cl. G06Q 30/00

(52) U.S. Cl. 705/14

(57) ABSTRACT

An advertiser can request to advertise on a property (online or offline) that does not participate in advertising network. The advertiser may specify how much it would be willing to pay to advertise on the property, among other constraints (e.g., time, geotargeting, etc.) An advertising network or an independent entity can contact the non-participating property, and may include information about the interest that advertiser(s) have expressed in advertising on the property. The information may be some value aggregated over a number of advertisers. The form of the contact (e.g., email, telephone call, in person visit, etc.) can be a function of the level of interest expressed.

### § 1. BACKGROUND OF THE INVENTION

§ 1.1 Field of the Invention

The present invention concerns advertising, such as online advertising. In particular, the present invention concerns helping ad networks to help match advertisers with desired properties.

§ 1.2 Background Information

Advertisers have long used traditional media formats, such as magazines, newspapers, television shows, etc., to reach an audience or to target an audience. Recently, advertising over more interactive media has become popular. For example, as the number of people using the Internet has exploded, advertisers have come to appreciate media and services offered over the Internet as a potentially powerful way to advertise.

Interactive advertising provides opportunities for advertisers to target their ads to a receptive audience. That is, targeted ads are more likely to be useful to end users since the ads may be relevant to a need inferred from some user activity (e.g., relevant to a user's search query to a search engine, relevant to content in a document requested by the user, relevant to an event being attended by a user, etc.). Query keyword targeting has been used by search engines to deliver relevant ads. For example, the AdWords advertising system by Google of Mountain View, Calif., delivers ads targeted to keywords from search queries. Similarly, content targeted ad delivery systems have been proposed. For example, U.S. patent application Ser. No. 10/314,427 (incorporated herein by reference and referred to as “the '427 application”) titled “METHODS AND APPARATUS FOR SERVING RELEVANT ADVERTISEMENTS”, filed on Dec. 6, 2002 and listing Jeffrey A. Dean, Georges R. Harik and Paul Buchheit as inventors; and Ser. No. 10/375,900 (incorporated by reference and referred to as “the '900 application”) titled “SERVING ADVERTISEMENTS BASED ON CONTENT,” filed on Feb. 26, 2003 and listing Darrell Anderson, Paul Buchheit, Alex Carobus, Claire Cui, Jeffrey A. Dean, Georges R. Harik, Deepak Jindal and Narayanan Shivakumar as inventors, describe methods and apparatus for serving ads relevant to the content of a document, such as a Web page for example. Content targeted ad delivery systems, such as the AdSense advertising system by Google for example, have been used to serve ads on Web pages.

Presently, it is often difficult to match advertisers and owners of properties (anything on which ads can be presented, such as (online or offline) media properties for example). In the following, the term “properties” is used to mean, depending on the context in which it is used, either the property itself or the owner of the property (or a proxy for the property owner). Advertisers seek distribution for their ads and properties seek advertisers, however bringing the two together and having them reach an agreement is often a cumbersome and lengthy task. Traditionally, an advertiser will manage multiple media buys on their own or use a media buying agency which specializes in a particular media format (e.g., TV, radio, outdoor, print, etc.) to plan, negotiate and execute their advertising plan. These processes are often time consuming, and therefore expensive. Further, these processes have a high degree of variability in outcome based upon various imperfect estimates of supply and demand from all parties.

An “ad network” is an aggregated set of properties (e.g., Websites) on which advertisers can place ads by paying a single party. Such ad networks have been useful intermediaries between advertisers and properties. Ad networks can aggregate information about supply and demand and use this information to help advertisers find properties with available ad spots. Ad networks often allow properties to set conditions under which they would accept advertising, and often allow advertisers to target their advertising. Google's AdWords and AdSense are examples of ad networks. Various contextual advertising products offered by companies such as Google, Overture, Industry Brains, Quigo, etc. act as ad networks in that they facilitate the distribution of ads directly to Websites or across a network of Websites, and also collect information needed to facilitate a transaction.

Although existing ad networks have proven to be very useful, they could be better. For example, advertisers may want to advertise on properties (e.g., Websites) that do not currently participate in the ad network. Unfortunately, such ad networks currently have no formal procedures or means to allow advertisers to express their interest in properties that don't participate in the ad network. Current online ad networks do not allow advertisers to make offers (e.g., bid) on Websites outside of the current ad network.

In view of the foregoing problems with existing ad networks, it would be useful to improve ad networks to help gauge advertiser interest in properties (and perhaps advertisers) outside of the ad network, and to use such heretofore unappreciated or underappreciated interest to help improve the ad network.

### § 2. SUMMARY OF THE INVENTION

An advertiser can request to advertise on a property (online or offline) that does not participate in advertising network. The advertiser may specify how much it would be willing to pay to advertise on the property, among other constraints (e.g., time, geotargeting, etc.) An advertising network or an independent entity can contact the non-participating property, and may include information about the interest that advertiser(s) have expressed in advertising on the property. The information may be some value aggregated over a number of advertisers. The form of the contact (e.g., email, telephone call, in person visit, etc.) can be a function of the level of interest expressed.

### § 3. BRIEF DESCRIPTION OF THE DRAWINGS

FIG. 1 is a diagram illustrating an environment in which, or with which, embodiments consistent with the present invention may operate.

FIG. 2 is a flow diagram of an exemplary method for performing at least some ad network operations in a manner consistent with the present invention.

FIG. 3 is an example of a display screen of an exemplary advertiser user interface consistent with the present invention.

FIG. 4 is a block diagram of apparatus that may be used to perform at least some operations, and store at least some information, in a manner consistent with the present invention.

### § 4. DETAILED DESCRIPTION

The present invention may involve novel methods, apparatus, message formats, and/or data structures for helping an ad network determine and/or prioritize properties (e.g., Websites) to solicit for purposes of adding such properties to the ad network. The following description is presented to enable one skilled in the art to make and use the invention, and is provided in the context of particular applications and their requirements. Thus, the following description of embodiments consistent with the present invention provides illustration and description, but is not intended to be exhaustive or to limit the present invention to the precise form disclosed. Various modifications to the disclosed embodiments will be apparent to those skilled in the art, and the general principles set forth below may be applied to other embodiments and applications. For example, although a series of acts may be described with reference to a flow diagram, the order of acts may differ in other implementations when the performance of one act is not dependent on the completion of another act. Further, non-dependent acts may be performed in parallel. No element, act or instruction used in the description should be construed as critical or essential to the present invention unless explicitly described as such. Also, as used herein, the article “a” is intended to include one or more items. Where only one item is intended, the term “one” or similar language is used. Thus, the present invention is not intended to be limited to the embodiments shown and the inventors regard their invention to include any patentable subject matter described.

In the following definitions of terms that may be used in the specification are provided in § 4.1. Then, environments in which, or with which, the present invention may operate are described in § 4.2. Exemplary embodiments of the present invention are described in § 4.3. Thereafter, a specific example illustrating the usefulness of one exemplary embodiment of the present invention is provided in § 4.4. Finally, some conclusions regarding the present invention are set forth in § 4.5.

§ 4.1 Definitions

Online ads may have various intrinsic features. Such features may be specified by an application and/or an advertiser. These features are referred to as “ad features” below. For example, in the case of a text ad, ad features may include a title line, ad text, and an embedded link. In the case of an image ad, ad features may include images, executable code, and an embedded link. Depending on the type of online ad, ad features may include one or more of the following: text, a link, an audio file, a video file, an image file, executable code, embedded information, etc.

When an online ad is served, one or more parameters may be used to describe how, when, and/or where the ad was served. These parameters are referred to as “serving parameters” below. Serving parameters may include, for example, one or more of the following: features of (including information on) a document on which, or with which, the ad was served, a search query or search results associated with the serving of the ad, a user characteristic (e.g., their geographic location, the language used by the user, the type of browser used, previous page views, previous behavior, user account, any Web cookies used by the system, user device characteristics, etc.), a host or affiliate site (e.g., America Online, Google, Yahoo) that initiated the request, an absolute position of the ad on the page on which it was served, a position (spatial or temporal) of the ad relative to other ads served, an absolute size of the ad, a size of the ad relative to other ads, a color of the ad, a number of other ads served, types of other ads served, time of day served, time of week served, time of year served, etc. Naturally, there are other serving parameters that may be used in the context of the invention.

Although serving parameters may be extrinsic to ad features, they may be associated with an ad as serving conditions or constraints. When used as serving conditions or constraints, such serving parameters are referred to simply as “serving constraints” (or “targeting criteria”). For example, in some systems, an advertiser may be able to target the serving of its ad by specifying that it is only to be served on weekdays, no lower than a certain position, only to users in a certain location, etc. As another example, in some systems, an advertiser may specify that its ad is to be served only if a page or search query includes certain keywords or phrases. As yet another example, in some systems, an advertiser may specify that its ad is to be served only if a document being served includes certain topics or concepts, or falls under a particular cluster or clusters, or some other classification or classifications. In some systems, an advertiser may specify that its ad is to be served only to (or is not to be served to) user devices having certain characteristics. Finally, in some systems an ad might be targeted so that it is served in response to a request sourced from a particular location, or in response to a request concerning a particular location.

“Ad information” may include any combination of ad features, ad serving constraints, information derivable from ad features or ad serving constraints (referred to as “ad derived information”), and/or information related to the ad (referred to as “ad related information”), as well as an extension of such information (e.g., information derived from ad related information).

The ratio of the number of selections (e.g., clickthroughs) of an ad to the number of impressions of the ad (i.e., the number of times an ad is rendered) is defined as the “selection rate” (or “clickthrough rate”) of the ad.

A “conversion” is said to occur when a user consummates a transaction related to a previously served ad. What constitutes a conversion may vary from case to case and can be determined in a variety of ways. For example, it may be the case that a conversion occurs when a user clicks on an ad, is referred to the advertiser's Web page, and consummates a purchase there before leaving that Web page. Alternatively, a conversion may be defined as a user being shown an ad, and making a purchase on the advertiser's Web page within a predetermined time (e.g., seven days). In yet another alternative, a conversion may be defined by an advertiser to be any measurable/observable user action such as, for example, downloading a white paper, navigating to at least a given depth of a Website, viewing at least a certain number of Web pages, spending at least a predetermined amount of time on a Website or Web page, registering on a Website, etc. Often, if user actions don't indicate a consummated purchase, they may indicate a sales lead, although user actions constituting a conversion are not limited to this. Indeed, many other definitions of what constitutes a conversion are possible.

The ratio of the number of conversions to the number of impressions of the ad (i.e., the number of times an ad is rendered) is referred to as the “conversion rate.” If a conversion is defined to be able to occur within a predetermined time since the serving of an ad, one possible definition of the conversion rate might only consider ads that have been served more than the predetermined time in the past.

A “property” is something on which ads can be presented. A property may include online content (e.g., a Website, an MP3 audio program, online games, etc.), offline content (e.g., a newspaper, a magazine, a theatrical production, a concert, a sports event, etc.), and/or offline objects (e.g., a billboard, a stadium score board, and outfield wall, the side of truck trailer, etc.). Properties with content (e.g., magazines, newspapers, Websites, email messages, etc.) may be referred to as “media properties.” Although properties may themselves be offline, pertinent information about a property (e.g., attribute(s), topic(s), concept(s), category(ies), keyword(s), relevancy information, type(s) of ads supported, etc.) may be available online. For example, an outdoor jazz music festival may have entered the topics “music” and “jazz”, the location of the concerts, the time of the concerts, artists scheduled to appear at the festival, and types of available ad spots (e.g., spots in a printed program, spots on a stage, spots on seat backs, audio announcements of sponsors, etc.).

A “document” is to be broadly interpreted to include any machine-readable and machine-storable work product. A document may be a file, a combination of files, one or more files with embedded links to other files, etc. The files may be of any type, such as text, audio, image, video, etc. Parts of a document to be rendered to an end user can be thought of as “content” of the document. A document may include “structured data” containing both content (words, pictures, etc.) and some indication of the meaning of that content (for example, e-mail fields and associated data, HTML tags and associated data, etc.) Ad spots in the document may be defined by embedded information or instructions. In the context of the Internet, a common document is a Web page. Web pages often include content and may include embedded information (such as meta information, hyperlinks, etc.) and/or embedded instructions (such as JavaScript, etc.). In many cases, a document has an addressable storage location and can therefore be uniquely identified by this addressable location. A universal resource locator (URL) is an address used to access information on the Internet.

A “Web document” includes any document published on the Web. Examples of Web documents include, for example, a Website or a Web page.

“Document information” may include any information included in the document, information derivable from information included in the document (referred to as “document derived information”), and/or information related to the document (referred to as “document related information”), as well as an extensions of such information (e.g., information derived from related information). An example of document derived information is a classification based on textual content of a document. Examples of document related information include document information from other documents with links to the instant document, as well as document information from other documents to which the instant document links.

Content from a document may be rendered on a “content rendering application or device”. Examples of content rendering applications include an Internet browser (e.g., Explorer, Netscape, Opera, Firefox, etc.), a media player (e.g., an MP3 player, a Realnetworks streaming audio file player, etc.), a viewer (e.g., an Abobe Acrobat pdf reader), etc.

A “content owner” is a person or entity that has some property right in the content of a document. A content owner may be an author of the content. In addition, or alternatively, a content owner may have rights to reproduce the content, rights to prepare derivative works of the content, rights to display or perform the content publicly, and/or other proscribed rights in the content. Although a content server might be a content owner in the content of the documents it serves, this is not necessary. A “Web publisher” is an example of a content owner.

“Verticals” are groups of related products, services, industries, content formats, audience demographics, and/or topics that are likely to be found in, or for, Website content.

A “cluster” is a group of elements that tend to occur closely together. For example, a cluster may be a set of terms that tend to co-occur often (e.g., on Web pages, in search queries, in product catalogs, in articles (online or offline) in speech, in discussion or e-mail threads, etc.).

“User information” may include user behavior information and/or user profile information.

“E-mail information” may include any information included in an e-mail (also referred to as “internal e-mail information”), information derivable from information included in the e-mail and/or information related to the e-mail, as well as extensions of such information (e.g., information derived from related information). An example of information derived from e-mail information is information extracted or otherwise derived from search results returned in response to a search query composed of terms extracted from an e-mail subject line. Examples of information related to e-mail information include e-mail information about one or more other e-mails sent by the same sender of a given e-mail, or user information about an e-mail recipient. Information derived from or related to e-mail information may be referred to as “external e-mail information.”

§ 4.2 Exemplary Advertising Environments in which, or with which, the Present Invention may Operate

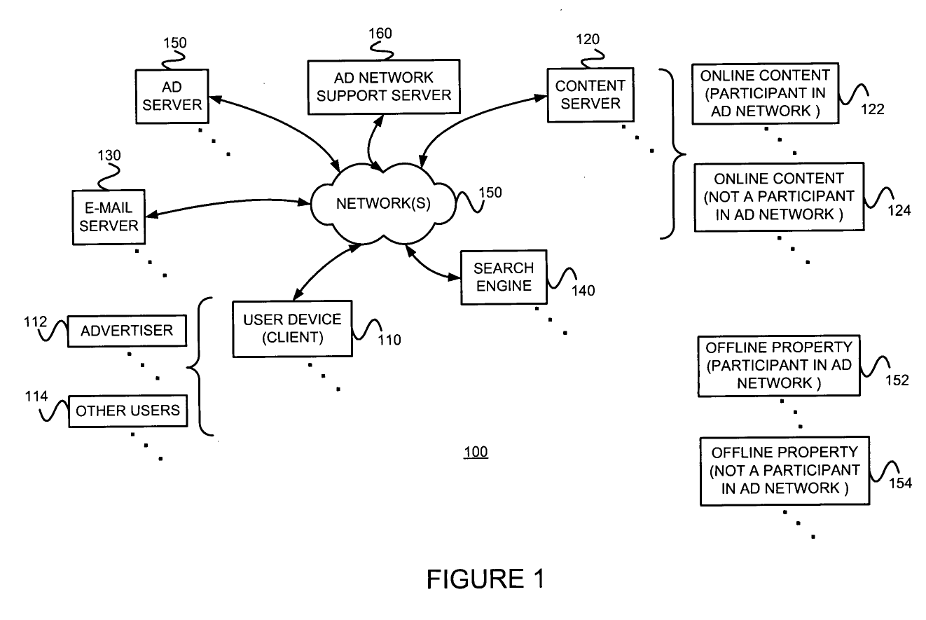

FIG. 1 illustrates an environment 100 in which embodiments consistent with the present invention may be used. A user device (also referred to as a “client” or “client device”) 110 may include a browser facility (such as the Explorer browser from Microsoft, the Opera Web Browser from Opera Software of Norway, the Navigator browser from AOL/Time Warner, the Firefox browser from Mozilla, etc.), an e-mail facility (e.g., Outlook from Microsoft), etc. A content server 120 may permit user devices 110 to access documents. An e-mail server (such as GMail from Google, Hotmail from Microsoft Network, Yahoo Mail, etc.) 130 may be used to provide e-mail functionality to user devices 110. A search engine 140 may permit user devices 110 to search collections of documents (e.g., Web pages). An ad server 150 may be used to serve ads to user devices 110. The ads may be served in association with search results provided by the search engine 140. However, content-relevant ads may be served in association with content provided by the content server 120, and/or e-mail supported by the e-mail server 130 and/or user device e-mail facilities. Object attribute or context relevant ads may be determined for various properties, including offline properties for example.

The user devices 110 may include, for example, one or more advertiser client devices 112, and client devices for one or more other users 114. Advertiser client devices 112 may interact with ad server 150 and/or ad network support server 160 via a user interface to allow advertisers to directly, or indirectly, enter, maintain, and track ad information. The ads may be in the form of graphical ads such as so-called banner ads, text only ads, image ads, audio ads, video ads, ads combining one of more of any of such components, etc. The ads may also include embedded information, such as a link, and/or machine executable instructions.

The content servers 120 may serve online content (i.e., online properties such as Websites, Web pages, etc.) 122 and 124. If the ad server 150 is a content ad server, it may have agreements with one or more content providers (to place ads on their properties) and with one or more advertisers 112 (to present their ads with content). The combination of the advertisers and content providers participating with a content ad server 150 may be thought of as an example of an “advertising network” (or “ad network”). Online content may include content that participates in the ad network 122, as well as content that does not participate in the ad network 124. Similarly, offline properties (e.g., properties where an ad may be placed, such as newspapers, magazines, periodicals, theatrical productions, sporting events, concerts, fairs, festivals, billboards, etc.) may include properties that participate in the ad network 152, as well as properties that do not participate in the ad network 154. Although such properties 152, 154 may themselves be offline, pertinent information about a property (e.g., attribute(s), topic(s), concept(s), category(ies), keyword(s), relevancy information, type(s) of ads supported, etc.) may be available online. For example, an outdoor jazz music festival may have entered the topics “music” and “jazz”, the location of the concerts, the time of the concerts, artists scheduled to appear at the festival, and types of available ad spots (e.g., spots in a printed program, spots on a stage, spots on seat backs, audio announcements of sponsors, etc.).

The ad server 150 may be similar to the one described in the '900 application. An advertising program may include information concerning accounts, campaigns, creatives, targeting, etc. The term “account” relates to information for a given advertiser (e.g., a unique e-mail address, a password, billing information, etc.). A “campaign” or “ad campaign” refers to one or more groups of one or more advertisements, and may include a start date, an end date, budget information, geo-targeting information, syndication information, etc. For example, Honda may have one advertising campaign for its automotive line, and a separate advertising campaign for its motorcycle line. The campaign for its automotive line may have one or more ad groups, each containing one or more ads. Each ad group may include targeting information (e.g., a set of keywords, a set of one or more topics, etc.), and price information (e.g., cost, average cost, or maximum cost (per impression, per selection, per conversion, etc.)). Therefore, a single cost, a single maximum cost, and/or a single average cost may be associated with one or more keywords, and/or topics. As stated, each ad group may have one or more ads or “creatives” (That is, ad content that is ultimately rendered to an end user.). Each ad may also include a link to a URL (e.g., a landing Web page, such as the home page of an advertiser, or a Web page associated with a particular product or server). Naturally, the ad information may include more or less information, and may be organized in a number of different ways.

Ad consumers may submit requests for ads to, accept ads responsive to their request from, and provide usage information to, the ad server 150. An entity other than an ad consumer may initiate a request for ads. Although not shown, other entities may provide usage information (e.g., whether or not a conversion or selection related to the ad occurred) to the ad server 150. This usage information may include measured or observed user behavior related to ads that have been served.

As discussed in the '900 application, ads may be targeted to documents served by content servers. Thus, one example of an ad consumer is a general content server 120 that receives requests for documents (e.g., articles, discussion threads, music, video, graphics, search results, Web page listings, etc.), and retrieves the requested document in response to, or otherwise services, the request. The content server may submit a request for ads to the ad server 150. Such an ad request may include a number of ads desired. The ad request may also include document request information. This information may include the document itself (e.g., page), a category or topic corresponding to the content of the document or the document request (e.g., arts, business, computers, arts-movies, arts-music, etc.), part or all of the document request, content age, content type (e.g., text, graphics, video, audio, mixed media, etc.), geo-location information, document information, etc.

The content server 120 may combine the requested document with one or more of the advertisements provided by the ad server 150. This combined information including the document content and advertisement(s) is then forwarded towards the end user device 110 that requested the document, for presentation to the user. Finally, the content server 120 may transmit information about the ads and how, when, and/or where the ads are to be rendered (e.g., position, selection or not, impression time, impression date, size, conversion or not, etc.) back to the ad server 150. Alternatively, or in addition, such information may be provided back to the ad server 150 by some other means.

Another example of an ad consumer is the search engine 140. A search engine 140 may receive queries for search results. In response, the search engine may retrieve relevant search results (e.g., from an index of Web pages). An exemplary search engine is described in the article S. Brin and L. Page, “The Anatomy of a Large-Scale Hypertextual Search Engine,” Seventh International World Wide Web Conference, Brisbane, Australia and in U.S. Pat. No. 6,285,999 (both incorporated herein by reference). Such search results may include, for example, lists of Web page titles, snippets of text extracted from those Web pages, and hypertext links to those Web pages, and may be grouped into a predetermined number of (e.g., ten) search results.

The search engine 140 may submit a request for ads to the ad server 150. The request may include a number of ads desired. This number may depend on the search results, the amount of screen or page space occupied by the search results, the size and shape of the ads, etc. In one embodiment, the number of desired ads will be from one to ten, and preferably from three to five. The request for ads may also include the query (as entered or parsed), information based on the query (such as geolocation information, whether the query came from an affiliate and an identifier of such an affiliate), and/or information associated with, or based on, the search results. Such information may include, for example, identifiers related to the search results (e.g., document identifiers or “docIDs”), scores related to the search results (e.g., information retrieval (“IR”) scores such as dot products of feature vectors corresponding to a query and a document, Page Rank scores, and/or combinations of IR scores and Page Rank scores), snippets of text extracted from identified documents (e.g., Web pages), full text of identified documents, topics of identified documents, feature vectors of identified documents, etc.

The search engine 140 may combine the search results with one or more of the advertisements provided by the ad server 150. This combined information including the search results and advertisement(s) is then forwarded towards the user that submitted the search, for presentation to the user. Preferably, the search results are maintained as distinct from the ads, so as not to confuse the user between paid advertisements and presumably neutral search results.

The search engine 140 may transmit information about the ad and when, where, and/or how the ad was to be rendered (e.g., position, selection or not, impression time, impression date, size, conversion or not, etc.) back to the ad server 150. Alternatively, or in addition, such information may be provided back to the ad server 150 by some other means.

Finally, the e-mail server 130 may be thought of, generally, as a content server in which a document served is simply an e-mail. Further, e-mail applications (such as Microsoft Outlook for example) may be used to send and/or receive e-mail. Therefore, an e-mail server 130 or application may be thought of as an ad consumer. Thus, e-mails may be thought of as documents, and targeted ads may be served in association with such documents. For example, one or more ads may be served in, under, over, or otherwise in association with an e-mail.

Although the foregoing examples described servers as (i) requesting ads, and (ii) combining them with content, one or both of these operations may be performed by a client device (such as an end user computer for example).

The ad network support server(s) 160 may be used to perform various operations consistent with the present invention. The ad network support server(s) 160 may belong to an ad network including ad server 150, or may be independent of ad servers 150 and ad networks. Indeed, the ad network support server(s) 160 may support more than one ad network.

§ 4.3 Exemplary Embodiments

Exemplary methods, advertiser user interfaces, and apparatus, consistent with the present invention, are described below.

§ 4.3.1 Exemplary Methods

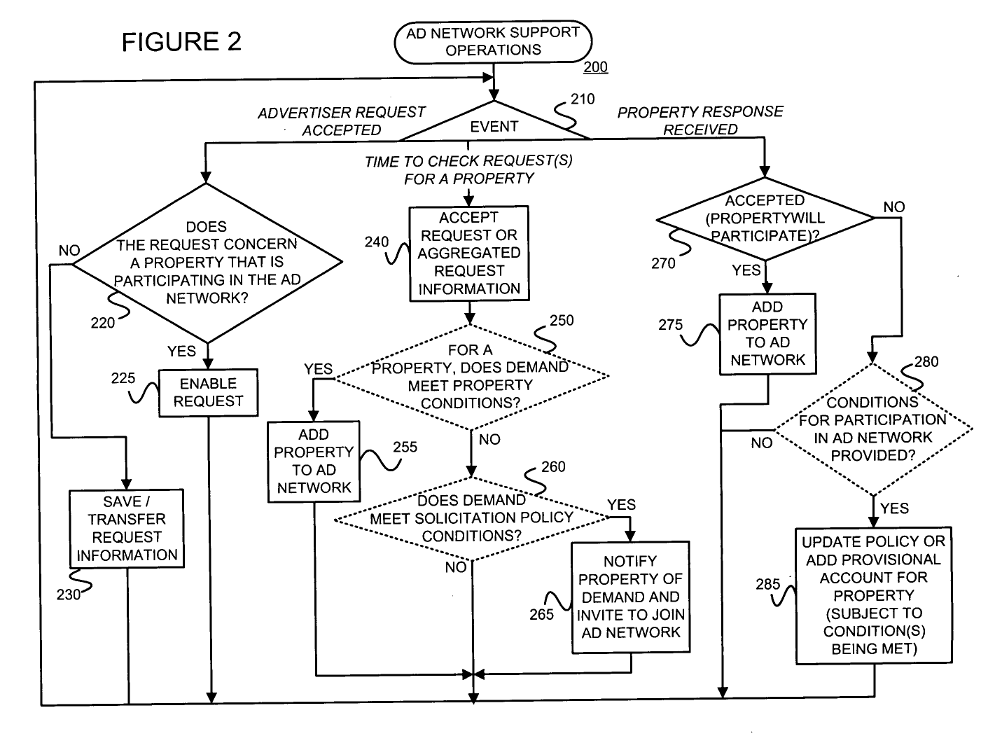

FIG. 2 is a flow diagram of an exemplary method 200 for performing at least some ad network support operations in a manner consistent with the present invention. Referring to event block 210, different branches of the method 200 may be performed in response to the occurrence of different events. For example, if an advertiser request is received, the left branch of the method 200 may be performed. An advertiser request may include one or more properties (e.g., Websites) that it wishes to place an ad on, serving constraints, offer information (e.g., an offer per impression, an offer per selection, an offer per conversion, a maximum offer per impression, a maximum offer per selection, a maximum offer per conversion, etc.), budget constraints (e.g., a maximum spend for a given time period), spend goals (e.g., a desire to spend a certain amount for a given time period), etc. Note that the offer information in the request may correspond to a single property (e.g., www.edmunds.com), or some group of properties (all Websites under the category automotive/new_cars, a list including a number of Websites, etc.).

Still referring to FIG. 2, if an advertiser request is accepted, it is determined whether the request concerns a property that is presently participating in the ad network. (Decision block 220) If so, the request is enabled so that the advertiser's ad(s) become eligible (perhaps subject to some other conditions) to be placed on the property (Block 225) before the method 200 proceeds back to event block 210. If, on the other hand, the property is not presently participating in the ad network, the request information is saved and/or transferred for further processing (Block 230), such as described below, before the method 200 proceeds back to event block 210.

Referring back to event block 210, if it is time to check requests for a property or properties that do not belong to the ad network, the middle branch of the method 200 is performed. Note that the time to check requests may be event driven (e.g., check when a transferred request is received, check when a predetermined number of requests are stored, etc.), may occur periodically (e.g., daily, weekly, etc.), etc. Further, requests for different properties may be processed separately, at different times responsive to different events, or may be processed together, substantially at the same time.

Still referring to FIG. 2, information from a request or from an aggregation of requests is accepted 240. Using this information, it is determined, for a given property (or group of properties), whether or not the demand meets conditions previously provided by the property. (Block 250) If so, the property may be added to the ad network 255 before the method 200 proceeds back to event block 210. If and when the property is added to the ad network, advertisers that have previously targeted the property and that have submitted an offer for the property may begin to compete with other advertisers to have their ad placed on the newly added property. If, on the other hand, the demand does not meet previously provided property conditions, the method 200 may continue to decision block 260. At decision block 260, it is determined whether or not the demand meets solicitation policy conditions. If not, the method 200 may simply proceed back to event block 210. If, on the other hand, it is determined that the demand meets solicitation policy conditions, the method 200 may notify the property of the advertiser demand to place ads on its property and invite the property to join the ad network (Block 265) before the method 200 proceeds back to event block 210.

Referring back to event block 210, if a response (e.g., to the earlier notification of Block 265) is received from a property, the right branch of the method 200 is performed. More specifically, it is determined whether the response is an indication that property will participate in the ad network (e.g., invitation to join ad network accepted). If so, the property is added to the ad network (Block 275) before the method 200 proceeds back to event block 210. If, on the other hand, it is determined that the response is an indicated that the property will not participate in the ad network, the method 200 may simply proceed back to event block 210, or may proceed to block 280 where it is determined whether or not the property response included conditions under which it would participate in the ad network. If the response does not include such conditions, the method 200 may simply proceed back to event block 210. If, on the other hand, the response includes such conditions, conditions (Recall, e.g., those that may be checked in decision block 250.) may be updated and/or a provisional account (to be activated if and when the conditions are met) may be added for the property (Block 285) before the method 200 proceeds back to event block 210.

Referring back to both block 230 and event block 210 of FIG. 2, in at least some embodiments consistent with the present invention, the request may be immediately analyzed (to determine if it meets the conditions of a property and/or to determine if it should trigger a solicitation to the property) upon transfer.

Referring back to block 250 of FIG. 2, a property may define various conditions to be met before it will join the ad network. For example, it may require only text ads and be willing to join the ad network only if it can generate (e.g., guaranteed) revenue for a given time period, it may require the advertisers to each have a certain market value or advertisers to have a certain aggregate market value, it may limit the types of offers (e.g., bid per impression only), etc.

Referring back to block 260, the solicitation policies may be general policies, policies for various types (e.g., profiles) of properties, and/or policies for a particular properties. Policies may include a minimum threshold aggregate expected revenue, property not contacted within a past predetermined time period, certain modes of solicitation to be used or not to be used, etc. Thus, for example, a general policy may be to contact properties when aggregated expected monthly revenue exceeds $1,000.00. A specific policy may be contact Forbes.com only if aggregated expected monthly revenue exceeds $50,000.00 and only by a personal sales representative with a certain level of training and experience.

In some embodiments consistent with the present invention, an inactive (e.g. pre-populated) property account may be associated with the solicitation. In addition, information from the inactive property account may be sent to the property for approval and account activation.

Referring back to conditional blocks 270 and 280, suppose an email solicitation was sent to a Website owner advising it that “If you join the Acme Ad network, you can expect to receive $1,000.00 per month.” The Website owner might reply, I don't want to join now, but I will join the Acme Ad network if and when expected revenue for text-only ads is guaranteed to exceed $2500.00 per month.

Referring back to the left branch of FIG. 2, since an advertiser request may include more than one property, it is possible that at least one of the properties of the request is in the ad network, while at least one of the other properties of the request is not in the ad network. In this case, the request may be bifurcated into two parts—a first part with the property or properties in the ad network is enabled (Recall Block 225.), while a second part with property or properties not in the ad network is saved or transferred (Recall Block 230.).

§ 4.3.2 Exemplary User Interface

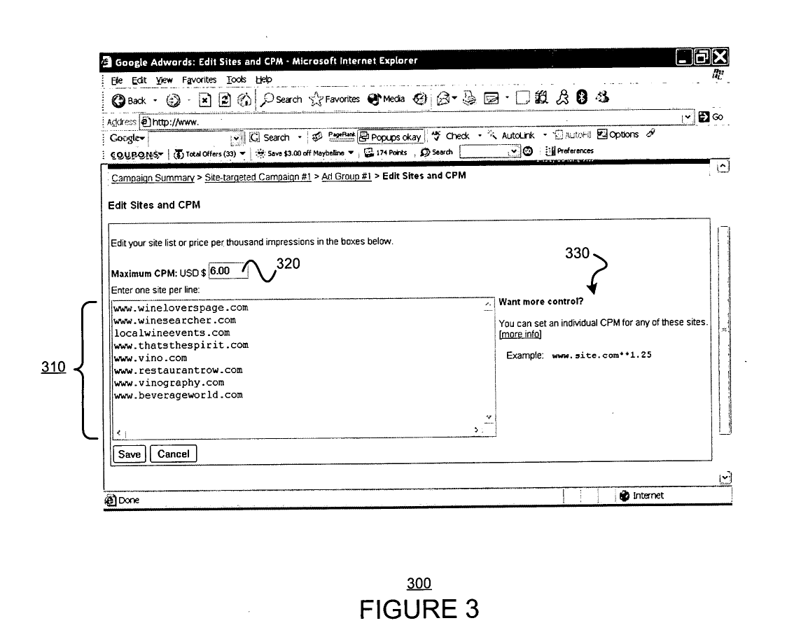

FIG. 3 is an example of a display screen 300 of an exemplary advertiser user interface consistent with the present invention. As shown, an advertiser user has provided, in text entry box 310, Websites that it is interested in adverting on. (Note that these Websites may have been suggested by a Website suggestion tool such as those described in U.S. patent application Ser. No. 11/______ (incorporated herein by reference), titled “SUGGESTING TARGETING INFORMATION FOR ADS, SUCH AS WEBSITES AND/OR CATEGORIES OF WEBSITES FOR EXAMPLE”, filed on Apr. 22, 2005 and listing Sumit Agarwal, Brian Axe, David Gehrking, Ching Law, Andrew Maxwell, Gokul Rajaram, and Leora Wiseman as inventors, and filed concurrently with the present application.) The advertiser may have been asked, “What properties would you like to be on and what would you pay.”

The advertiser user has also provided, in user entry box 320, a CPM offer (bid) of $6.00 per 1000 impressions. Note that the offer is applied to all of the listed Websites. As indicated by text 330, the advertiser can associate different offer information with different Websites.

§ 4.3.3 Exemplary Apparatus

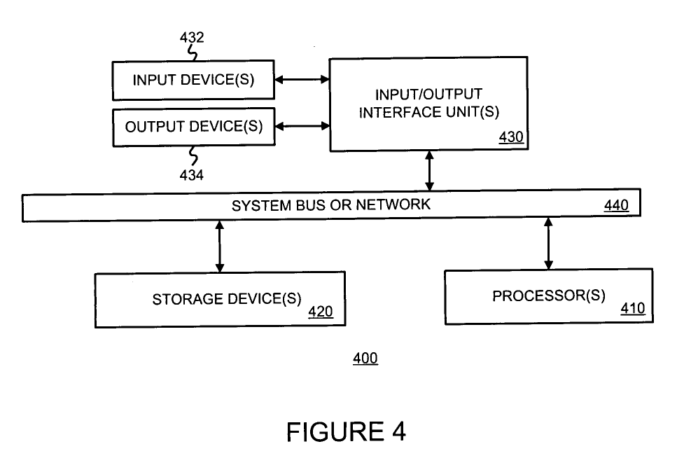

FIG. 4 is high-level block diagram of a machine 400 that may perform one or more of the operations discussed above. The machine 400 basically includes one or more processors 410, one or more input/output interface units 430, one or more storage devices 420, and one or more system buses and/or networks 440 for facilitating the communication of information among the coupled elements. One or more input devices 432 and one or more output devices 434 may be coupled with the one or more input/output interfaces 430.

The one or more processors 410 may execute machine-executable instructions (e.g., C or C++ running on the Solaris operating system available from Sun Microsystems Inc. of Palo Alto, Calif. or the Linux operating system widely available from a number of vendors such as Red Hat, Inc. of Durham, N.C.) to perform one or more aspects of the present invention. At least a portion of the machine executable instructions may be stored (temporarily or more permanently) on the one or more storage devices 420 and/or may be received from an external source via one or more input interface units 430.

In one embodiment, the machine 400 may be one or more conventional personal computers. In this case, the processing units 410 may be one or more microprocessors. The bus 440 may include a system bus. The storage devices 420 may include system memory, such as read only memory (ROM) and/or random access memory (RAM). The storage devices 420 may also include a hard disk drive for reading from and writing to a hard disk, a magnetic disk drive for reading from or writing to a (e.g., removable) magnetic disk, and an optical disk drive for reading from or writing to a removable (magneto-) optical disk such as a compact disk or other (magneto-) optical media.

A user may enter commands and information into the personal computer through input devices 432, such as a keyboard and pointing device (e.g., a mouse) for example. Other input devices such as a microphone, a joystick, a game pad, a satellite dish, a scanner, or the like, may also (or alternatively) be included. These and other input devices are often connected to the processing unit(s) 410 through an appropriate interface 430 coupled to the system bus 440. The output devices 434 may include a monitor or other type of display device, which may also be connected to the system bus 440 via an appropriate interface. In addition to (or instead of) the monitor, the personal computer may include other (peripheral) output devices (not shown), such as speakers and printers for example.

Referring back to FIG. 1, one or more machines 400 may be used as end user client devices 110, content servers 120, e-mail servers 130, search engines 140, ad servers 150, and/or ad network support servers 160.

§ 4.3.4 Refinements and Alternatives

Referring In at least some embodiments consistent with the present invention, for specified Webpages or advertising spots, rather than allowing the ad network to control which ads appear on their Website, properties could opt to directly manage the arbitration process themselves. In this case, the ad network could provide a listing of the advertisers who have submitted an offer for (e.g., bid on) the specified advertising space, along with additional advertiser quality measures (e.g. estimated clickthrough rate for each ad, derived in part from other placements of the ad), to assist the property in deciding which ad to approve for a given spot. This method would be used to allow properties to directly control the resolution of multiple bids for high demand inventory, ensuring that only the most desirable ads are shown on such properties.

Although the various embodiments consistent with the present invention were described in the context of advertisers expressing an interest in advertising on a property and perhaps soliciting the property to join an ad network using such expressed interest, other embodiments consistent with the present invention may be used in the reverse manner, to allow properties to express an interest if having certain advertisers advertise on them, and perhaps soliciting the advertiser to join the ad network or to target the property using such expressed interest. For example, properties might be asked, “What advertisers would you like to see and at what price?”

Although in some of the embodiments described above, the ad network itself performed the ad network support operations, such operations may be provided by a separate entity (e.g., a third party). Indeed, such a separate entity could service more than one ad network and could aggregate advertiser demand from more than one ad network.

§ 4.4 Examples of Operations

The following example illustrates the utility of an exemplary embodiment consistent with the present invention. First, an advertiser user creates account with ad network. Suppose, for example, that a sports apparel company wants to advertise NFL-licensed football jerseys. The advertiser specifies they want to purchase specific advertising space on a property (either online or offline). In this case, the advertiser might want to advertise on the Websites espn.com, cbssportsline.com, and at various football stadiums. More specifically, the advertiser specifies a list of properties on which it wishes to advertise. For each property, the advertiser specifies the price it's willing to pay, the number of impressions/clicks it would like, as well as other campaign information (timing, creative formats, etc). The advertiser could use either a specific identifier (Website URL) or otherwise supply enough descriptive data that we are able to match to a known property (e.g. ESPN's email newsletters). In this case, suppose that the advertiser specifies that it is willing to pay $15.00 per thousand impressions on the espn.com and cbssportsline.com, and has a monthly budget of $7500.00, and is willing to pay $5,000.00 per home game for its logo on a stadium scoreboard. The information from the advertiser's is stored in a database by the ad network. This allows the ad network to track which properties (and for each property, which slots) the advertiser wants to advertise on.

For a given property, if the property already participates in the ad network, the advertiser's request is automatically added to their current ad campaigns to be filled when possible. If, however, the property is not already part of the ad Network, the property may receive a communication from the advertising network informing it of the fact that an advertiser wants to advertise on the property (assuming that certain policies, if any, are met). Thus, the advertiser's request may be used to automatically generate a sales lead for the property. The communication can be generated individually for each advertiser, or demand from multiple advertisers for can be aggregated and presented to the property, or both.

In this example, suppose that the cbssportsline.com Website participates in the ad network, but the espn.com Website doesn't. Suppose further that all NFL stadiums except two participate in the ad network. The ad network may contact cbssportsline.com (e.g., via email) and notify it that it can guarantee $X per month in advertising revenue if it can generate Y impressions per month. (Note that if other advertisers expressed an interest in advertising on cbssportsline.com, it could aggregate this interest. Similarly, the ad network might contact the two football stadiums (e.g., via telephone) and notify it that it can sell $5,000.00 per home game for a logo placed on a stadium scoreboard.

The data communicated to the property can include as much or as little of the information entered by the individual advertisers as the advertising network wants. A shorter solicitation might include the number of advertisers desiring to advertise on the property, while a longer solicitation might include the details of each individual advertiser.

To take advantage of these sales leads, the property may enter into a relationship with the advertising network. The advertising network (along with presenting the sales leads) can create and pre-populate an inactive account for the property with information about the property. (The advertising network can obtain the contact information about the property by crawling the Website of the property or from other publicly available information sources). The property can then enter into a relationship with the ad network by simply clicking a button. Suppose for example, that cbssportsline.com was enticed to join the ad network. In at least some embodiments consistent with the present invention, it could do so by simply clicking a button (if information in a pre-populated inactive account was accurate). Suppose further that one of the two NFL stadiums decided to join the ad network. It could provide topics and/or keywords used to target ads (e.g., football, sports, outdoor concerts, NFL) to its stadium and describe various available ad spots (e.g., three 20″-by-36″ score board spots, 75 15″-by-24″ mezzanine overhang spots, 20 36″-by-48″ interior jewel case displays, 4 halftime 30 second announcements, etc.) and perhaps minimum amounts required.

Once the property is in the ad network, it can start presenting ads (through a wide variety of methods, mostly depending on the type of property). For example, in an online scenario, the property could receive a piece of code from the ad network, which they can place on their Website to start running ads. In an offline scenario, the property could receive the ads from the advertising network on a periodic basis.

### § 4.5 CONCLUSIONS

As can be appreciated from the foregoing, with advertiser-driven lead prospecting and demand aggregation under embodiments consistent with the present invention, an advertiser could seamlessly add properties to their advertising campaign by declaring their intent to advertise on a property directly. In at least some embodiments consistent with the present invention, advertisers may do this via a central interface or a tool which allows them to declare their intent while directly seeing the property (e.g. a web application which opens a window on a Website, gathers information from the browser and then routes that information back to the intermediaries database). The intent could be fulfilled (e.g., the advertisers ads might at least become eligible to be presented with the property) if conditions specified by the advertiser match the requirements specified by the property (e.g. “must run during this time frame”, “must be willing to pay X dollars”). If the property is not part of the ad network, the ad network could seek to meet the requirements of the property by sharing some degree of aggregated advertiser interest with the property in order to encourage them to register with the intermediary (e.g. “We have five advertisers who want to spend $10,000 with you. Click here to create an account.”)

What is claimed is:

1. A computer-implemented method comprising:
a) accepting, from an advertiser, an indication of interest in advertising on a property not included in an advertising network;
b) contacting an entity associated with the property to inform the entity of interest in advertising on the property.

2. The computer-implemented method of claim 1 further comprising:
c) receiving a response from the entity; and
d) adding the property to the advertising network based on the response received from the entity.

3. The computer-implemented method of claim 2 further comprising:
e) allowing advertisers that have previously indicated an interest in advertising on the property to compete to be placed on the property automatically once the property is added to the ad network.

4. The computer-implemented method of claim 1 wherein the indication of interest includes at least one of an offer per impression, an offer per selection, an offer per conversion, a maximum offer per impression, a maximum offer per selection and a maximum offer per conversion.

5. The computer-implemented method of claim 4 wherein the indication of interest includes at least one of how many impressions are desired by the advertiser, how many selections are desired by the advertiser, and how many conversions are desired by the advertiser.

6. The computer-implemented method of claim 4 wherein the indication of interest includes campaign information, including at least one of time targeting, location targeting, and ad format.

7. The computer-implemented method of claim 1 wherein the act of contacting an entity includes aggregating interest by a plurality of advertisers in advertising on the property.

8. The computer-implemented method of claim 1 wherein the act of contacting an entity uses a mode of contact that is selected using a level of interest in advertising on the property by the advertiser.

9. The computer-implemented method of claim 8 wherein the mode of contact is one of email, telephone call, and in-person solicitation.

10. The computer-implemented method of claim 1 wherein the act of contacting an entity uses a mode of contact that is selected using a level of interest in advertising on the property, in the aggregate, by a group of advertisers.

11. The computer-implemented method of claim 10 wherein the mode of contact is one of email, telephone call, and in-person solicitation.

12. The computer-implemented method of claim 1 wherein the act of contacting an entity includes providing to the entity at least one of (A) a set of one or more advertisers that have expressed an interest in advertising on the property, (B) an aggregate amount of money that one or more advertisers are willing to spend to advertise on the property, (C) a per advertiser amount of money that each advertiser is willing to spend to advertise on the property, and (D) a type of ad desired to be placed of the property.

13. The computer-implemented method of claim 1 wherein the act of contacting an entity includes providing the entity with a pre-populated inactive account for approval by the entity.

14. Apparatus comprising:
a) means for accepting, from an advertiser, an indication of interest in advertising on a property not included in an advertising network; and
b) means for contacting an entity associated with the property to inform the entity of interest in advertising on the property.
